(19) United States
(12) Patent Application Publication
(10) Pub. No.: US 2005/0027740 A1
(43) Pub. Date: Feb. 3, 2005

(54) Content information management apparatus and content information management method

(75) Inventors: Mitsuaki Moritani, Yokohama-shi (JP); Yasuhiro Morioka, Yokohama-shi (JP); Hiroshi Niina, Kawasaki-shi (JP); Kazuaki Iwamura, Ome-shi (JP); Ken Kishida, Hamura-shi (JP)

Correspondence Address: FOLEY & LARDNER, 2029 CENTURY PARK EAST, SUITE 3500, LOS ANGELES, CA, 90067, US

(73) Assignee: KABUSHIKI KAISHA TOSHIBA

(21) Appl. No.: 10/783,200

(22) Filed: Feb. 19, 2004

(30) Foreign Application Priority Data
Jul. 28, 2003 (JP) 2003-202642

(51) Int. Cl. G06F 17/00

(52) U.S. Cl. 707/104.1

(57) ABSTRACT

A content information management apparatus includes a collection processing unit which collects content information items indicating attributes of contents stored in different specific forms in storage devices connected to networks using different protocols, a conversion processing unit which converts each of the content information items collected by the collection processing unit into content information of a standardized form, and a display which displays the content information.

### CROSS-REFERENCE TO RELATED APPLICATIONS

This application is based upon and claims the benefit of priority from prior Japanese Patent Application No. 2003-202642, filed Jul. 28, 2003, the entire contents of which are incorporated herein by reference.

### BACKGROUND OF THE INVENTION

1. Field of the Invention

The present invention relates to a content information management apparatus which connects a plurality of devices using different protocols via networks and more particularly to a content information management apparatus and content information management method which make it possible to retrieve and transmit content data such as video images and music between devices using different protocols.

2. Description of the Related Art

It is known to use a method for recording, managing and reproducing content such as video images and music (which are hereinafter referred to as AV content) with respect to a medium such as a videotape or compact disc which is replaceable and can be physically dealt with. A more recent method uses a device (which is hereinafter referred to as an AV device) which has a hard disk to record or reproduce AV content, and records and holds the AV content as digital data on the built-in hard disk. Further, there is provided a method for connecting the AV devices via a network, permitting content to be retrieved and handled by use of another device and permitting content to be transferred, copied and reproduced between the devices.

For example, a device which permits data transmission between AV devices using an IEEE (Institute of Electrical and Electronics Engineers) 1394 system via a network using a serial bus of the IEEE 1394 system has been developed. Further, a device capable of performing data transmission and control between the AV devices using an IEEE 802 system network and TCP/IP network is developed.

In order to retrieve the AV content by use of the above network, for example, it is necessary to make common inquiry procedures (which are hereinafter referred to as inquiry protocols) on TCP/IP network between the AV devices using TCP/IP which is widely used. In the AV devices which perform the retrieving, transferring and reproducing processes of the content by use of the network, the inquiry protocols are independently set for respective AV devices and are not interchangeable. Therefore, it is required for the AV device which necessitates retrieval to cope with a plurality of necessary inquiry protocols. Further, the same problem occurs when a network other than a TCP/IP network is used.

### BRIEF SUMMARY OF THE INVENTION

Embodiments of the present invention may provide a content information management apparatus and content information management method which make it possible to access content information which is required to be retrieved by use of various inquiry protocols by using a standardized inquiry protocol.

According to one aspect of the present invention, there is provided a content information management apparatus comprising a collection processing unit which collects content information items indicating attributes of contents stored in different specific forms in storage devices connected to networks using different protocols; a conversion processing unit which converts each of the content information items collected by the collection processing unit into content information of a standardized form; and a display which displays the content information.

According to another aspect of the present invention, there is provided a content information management method comprising collecting a content information item indicating an attribute of content stored in a first form in a first storage device connected to a network using a first protocol and a content information item indicating an attribute of content stored in a second form in a second storage device connected to a network using a second protocol; and displaying each of the collected content information items in a standardized form.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a content information management apparatus and related devices according to one embodiment of the present invention;

FIG. 2 is a block diagram showing the detail functional configuration of a media management section;

FIG. 3 is a diagram showing the structure of a content directory in the media management section;

FIG. 4 is a flowchart for illustrating the outline of the operation of an inquiry receiving section;

FIG. 5 is a flowchart for illustrating the outline of the operation of an inquiry processing section;

FIG. 6 is a flowchart for illustrating the operation of the media management section at the starting time;

FIG. 7 is a flowchart for illustrating the operation of each monitor (inquiry processing section) at the starting time;

FIG. 8 is a flowchart for illustrating a device detection procedure by use of a monitor;

FIG. 9 is a flowchart for illustrating a searching procedure by use of a monitor;

FIG. 10 is a flowchart for illustrating a device event receiving procedure by use of a monitor;

FIG. 11 is a flowchart for illustrating the procedure of a response to a content retrieval request;

FIG. 12 is a flowchart for illustrating a response procedure in the case of retrieval of content information;

FIG. 13 is a flowchart for illustrating a response procedure in the case of creation of content information;

FIG. 14 is a flowchart for illustrating a response procedure in the case of deletion of content information;

FIG. 15 is a flowchart for illustrating a response procedure in the case of updating of content information;

FIG. 16 is a diagram showing an example of a form in which content recorded on a hard disk video recorder are held;

FIG. 17 is a diagram showing an example of a CDS form template in the case of a hard disk video recorder;

FIG. 18 is a diagram showing an example of a rule applied in the case of a hard disk video recorder;

FIG. 19 is a flowchart for illustrating a content information converting procedure;

FIG. 20 is a diagram showing an example of the result of conversion into a CDS form; and

FIG. 21 is a diagram showing an example in a case where information indicating the location of content is contained.

### DETAILED DESCRIPTION OF THE INVENTION

Embodiments of the present invention will be described below with reference to the drawings.

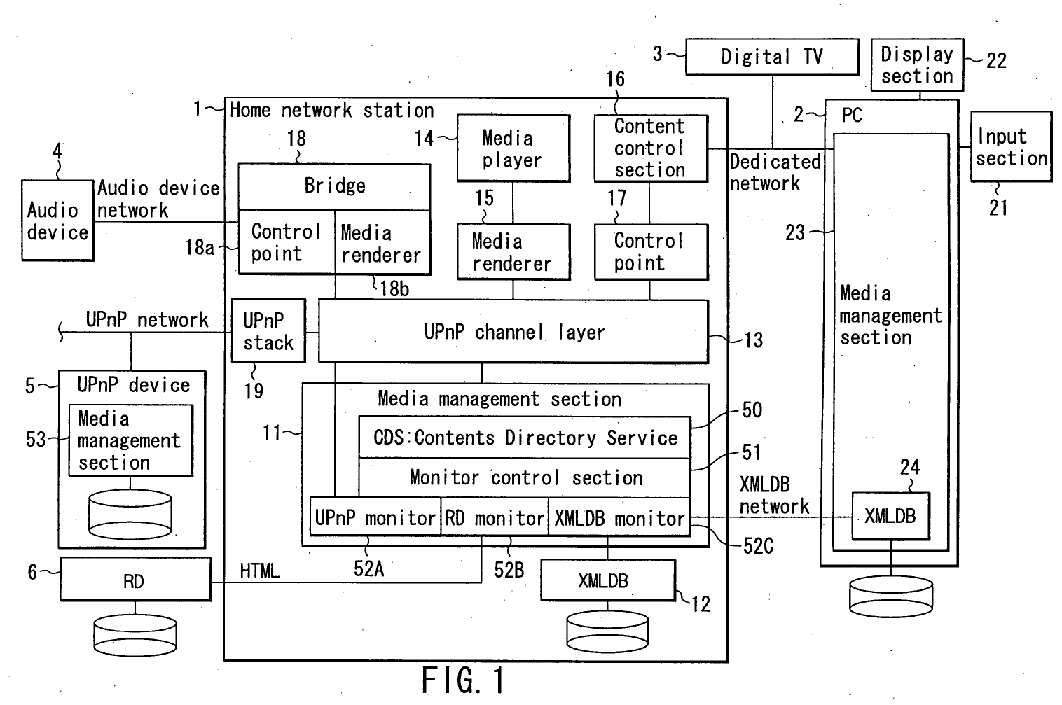

FIG. 1 is a block diagram showing the configuration of a content information management apparatus and related devices according to one embodiment of the present invention.

In the present embodiment, the content information management apparatus corresponds to a home network station (HNS) 1. The home network station 1 is realized, for example, with a personal computer and software. Various types of AV devices and information devices are connected to the home network station 1 via various networks which conform to general TCP/IP and dedicated protocols. The network used here may be an in-system network or may include the Internet.

For example, a personal computer (PC) 2 which is an information device and a digital TV device 3 which is an AV device are connected to the home network station 1 via a dedicated network. Further, the home network station 1 is connected to an audio device (which is a speaker, amplifier and the like) 4 via an audio device network, a UPnP (Universal Plug and Play) device 5 which is an AV device via a UPnP network and a hard disk video recorder (RD) 6 via an HTML network. In addition, the home network station 1 is connected to an XMLDB (which will be described later) in a PC 2 via an XMLDB network. Note that the AV devices 2-6 are basically media servers, each of which has, in the inside, a storage device (such as a HDD) and a communication device. Each AV device stores AV content in the storage device, and instructions concerning searches and manipulations of the AV content are allowed to be provided from the outside through the communication device.

The PC 2 is a device which can control the home network station 1 or one or plural ones of a plurality of AV devices. The PC 2 includes an input section 21 having a keyboard or mouse used by the user to issue various instructions, and a display section 22 which displays a play list (formed by collecting various types of content information items into one group) of contents on a display screen. For example, the user can issue various inquiries relating to information items indicating attributes of contents stored in storage devices of individual AV devices connected to the home network station 1 or a display request of a reproduction list of contents to the home network station 1 by use of the input section 21. In this case, it is impossible to directly make an inquiry relating to content information from the PC 2 to the AV device (for example, UPnP device 5, RD 6).

Further, the PC 2 includes a media management section 23 which manages contents such as video images and music. The media management section 23 has an XMLDB processing section 24 to store contents and content information or transfer the same with respect to the home network station 1 via the XMLDB network.

The digital television 3 outputs video/audio data based on a video signal/audio signal supplied thereto from the home network station 1 via the dedicated network.

The audio device 4 has a speaker and amplifier and outputs audio data based on an audio signal supplied from the home network station 1 via the audio device network.

The UPnP device 5 is an AV device which conforms to the UPnP protocol and includes a media management section 53 which manages contents such as video images and music on a storage medium.

The RD 6 is a hard disk video recorder which records and reads out contents such as video images and music on or from a storage medium. The RD 6 can make communication based on HTML with respect to the home network station 1.

The home network station 1 includes a media management section 11, XML database (XMLDB) 12, UPnP channel layer 13, media player 14, media renderer 15, content control section 16 (hardware or software), control point 17, bridge processing section 18, UPnP stack 19 and the like. The bridge processing section 18 includes a control point 18a and a media renderer 18b, and fetches AV content from the audio device 4 or transmits AV content in the home network station 1 to the audio device 4. The control points 17 and 18a refer to software that controls the AV devices via the network. The media renderer 15 and the media player 14 are software for reproducing AV content fetched from inside the home network station (e.g., server) 1, and the AV devices. The content control section 16 controls transmission of AV content, for example, to the PC 2 and the digital TV 3 connected to a dedicated network that complies with a communication protocol different from the UPnP standard.

The media management section 11 realizes a function as a media server conforming to UPnP. The media management section 11 performs an information retrieving process using the XMLDB 12 via a content directory service (which is hereinafter referred to as a CDS) 50 and makes a further inquiry via the network according to various inquiries (or requests) of content information from an inquiry source such as the PC 2. Then, it can return the result to the inquiry source (request source) via the network.

The CDS 50 of the present embodiment includes a monitor control section 51, UPnP monitor (or CDS monitor) 52A, RD monitor 52B and XMLDB monitor 52C. The monitor control section 51 controls the various monitors 52A, 52B, 52C. For example, the monitor control section 51 makes a request of an inquiry process with respect to a corresponding monitor in response to various inquiries of content information items from the inquiry source and notifies the inquiry source of the inquiry result.

The UPnP monitor 52A monitors content information of individual devices (such as the UPnP device 5) connected to the UPnP monitor 52A. The UPnP monitor 52A has a function of acquiring the content information at the required time, converting the same into a preset standardized form (in this case, a CDS form based on XML) and holding the thus converted content information on the XMLDB 12. Further, the UPnP monitor 52A has a function of retrieving or searching for corresponding content information on the XMLDB 12 according to the inquiry when a request of the content information inquiry process is received and returning the retrieval result as an inquiry response.

The RD monitor 52B monitors content information of individual devices (such as the RD 6) connected to the RD monitor 52B. The RD monitor 52B has a function of acquiring the content information at the required time, converting the same into a preset standardized form (in this case, a CDS form based on XML) and holding the thus converted content information on the XMLDB 12. Further, the RD monitor 52B has a function of retrieving corresponding content information on the XMLDB 12 according to the inquiry when a request of the content information inquiry process is received and returning the retrieval result as an inquiry response.

The XMLDB monitor 52C monitors content information of individual devices (such as the XMLDB 24) connected to the XMLDB monitor 52C. The XMLDB monitor 52C has a function of acquiring the content information at the required time, converting the same into a preset standardized form (in this case, a CDS form based on XML) and holding the thus converted content information on the XMLDB 12. Further, the XMLDB monitor 52C has a function of retrieving corresponding content information on the XMLDB 12 according to the inquiry when a request of the content information inquiry process is received and returning the retrieving result as an inquiry response.

The XMLDB 12 stores content information items which individual devices connected to the home network station 1 has in a standardized CDS form.

The UPnP channel layer 13 corresponds to a layer which performs the control process relating to the UPnP channel. The UPnp channel layer performs a bridge process between the media management section 11 and various functions (for example, of the media renderer 15, control point 17, bridge processing section 18, UPnP stack 19) other than the media management section.

The media player 14 is a software player which performs the reproduction process of contents such as video images and music. The media renderer 15 conforms to UPnP and processes audio data reproduced by the media player 14, for example.

The content control section 16 fetches various inquiries and requests from the PC 2 via the dedicated network, transmits play list data of contents to the PC 2 and supplies contents to the digital TV device 3. The control point 17 conforms to UPnP and processes data relating to various inquiries and requests from the PC 2.

The bridge processing section 18 processes audio data which the audio device 4 reproduces by use of a media renderer (conforming to UPnP) and processes data relating to specification of reproduction by use of a control point (conforming to UPnP).

The UPnP stack 19 is provided between the UPnP channel layer 13 and the UPnp network and has various layers required to attain an interface between them.

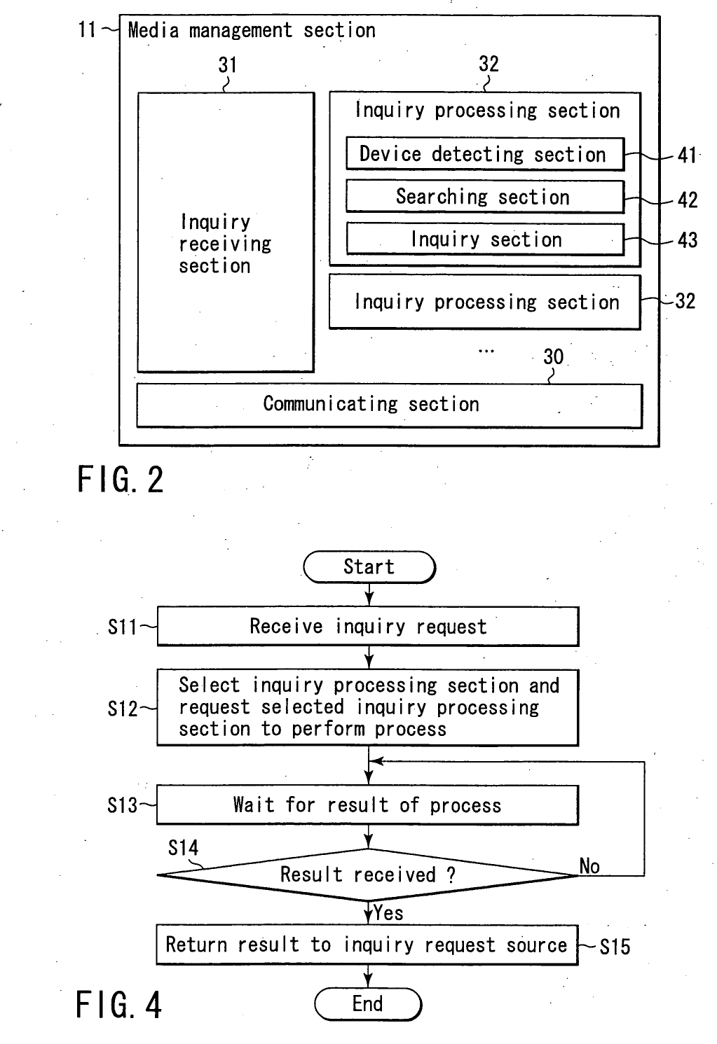

Next, the detail functional configuration of the media management section 11 is explained with reference to FIG. 2.

A communicating section 30 performs communication with devices connected to various monitors in addition to communication with the UPnP channel layer 13 shown in FIG. 1.

An inquiry receiving section 31 is realized by the monitor control section 51 shown in FIG. 1, for example. It receives an inquiry relating to content information of one or a plurality of AV devices from the PC 2 via the communicating section 30 and returns the inquiry result to the PC 2.

A plurality of inquiry processing sections 32 correspond to the monitors shown in FIG. 1 and are respectively provided for a plurality of AV devices (that is, for respective inquiry protocols of the AV devices). The inquiry processing sections 32 process inquiries received by the inquiry receiving section 31. For example, each of the plurality of inquiry processing sections 32 can collect content information from the individual storage devices connected to the corresponding network, convert the collected content information into content information of a standardized form and output the same.

The inquiry receiving section 31 selects one of the inquiry processing sections 32 according to the inquiry at the time of inquiry reception. Then, it leaves the inquiry process up to a selected one of the inquiry processing sections 32, waits for output of the processing result by the inquiry processing section 32, receives the processing result, and notifies the PC 2 of the processing result as an inquiry result via the communicating section 30. Further, for example, the inquiry receiving section 31 can generate information obtained by unifying the content information items of the standardized form output from the inquiry processing sections 32.

Further, after content information stored in the specific form in the individual storage devices connected to the networks using different protocols are collected, the inquiry receiving section 31 can output information which permits the collected content information items to be displayed in the standardized form on the display screen and is contained in transmission information to the PC 2 or the like. In this case, it is possible to perform a process for creating one play list by use of the collected content information items and displaying the same. Further, it is also possible to perform a process to sequentially output individual content indicated on the display of the play list from the corresponding storage device. It is possible to convert control information from the PC 2 into control information which can be dealt with in the standardized form, receive the same and perform a process according to the thus converted control information.

Each of the inquiry processing sections 32 includes a device detecting section 41, searching section 42 and inquiry section 43.

The device detecting section 41 detects an AV device on a network which can make an inquiry by use of a protocol of a received inquiry in advance or when it receives the inquiry.

The searching section 42 acquires content information held by an AV device detected by the device detecting section 41 based on the inquiry protocol of the AV device. Then, the searching section 42 converts the content information into a preset standardized form (in this case, a CDS system based on XML). That is, the searching section 42 converts the content information into information which the PC 2 can acquire in the standardized form and hold the thus converted information.

The inquiry section 43 retrieves content information acquired and held by the searching section 42 according to the inquiry and the property of the AV device. Then, the inquiry section 43 returns the result which satisfies the condition as an inquiry response to the inquiry receiving section 31.

Further, each of the inquiry processing sections 32 has a function of creating a reproduction list of contents stored in the storage media of the individual AV devices in a preset standardized form based on the converted content information items and returning the reproduction list as an inquiry response to the inquiry receiving section 31 when a request of display of the reproduction list of contents held in a plurality of AV devices is issued from the PC 2. Further, it also has a reproduction processing function of sequentially acquiring contents described in the reproduction list from the corresponding devices and outputting the same to the request source such as the PC 2.

It is assumed that the UPnP specification contains a UPnP AV specification which is a specification for AV. Next, the UPnP and UPnP AV operations are simply explained below. The PC 2 (as a controller) transmits a detection request packet to the surrounding devices in a multicast fashion based on SSDP (Simple Service Discovery Protocol). When receiving the detection request packet from the PC 2, the media management section 11 returns a detection response packet to the PC 2. Thus, the PC 2 recognizes that the media server (media management section 11) is present on the network. All of the UPnP devices can be detected by use of the detection request packet. In addition, only a specified device or a device having a specified function can be specified to make a response. Further, the PC 2 can selectively detect a necessary UPnP device.

An inquiry from the PC 2 to the media server (media management section 11) and a response with respect to the inquiry are made using SOAP (Simple Object Access Protocol). It is used to exchange the processing contents described in XML (Extensible Markup Language) using HTTP (Hyper Text Transfer Protocol) and a response thereof. Function names and arguments which can be used for the inquiry and response are previously prepared as a device description file or service description file by the UPnP device and are disclosed to the PC 2. A notification from the UPnP device to the PC 2 is made based on GENA (General Event Notification Architecture).

The UPnP AV corresponds to device definition and service definition for the AV device defined on the UPnP basic architecture. In this case, two sections of the media server and media renderer which are described before are defined as device functions. Further, four items of a connection manager, content directory (content management), AV transport (AV transport control) and rendering control (reproduction output control) are defined as service functions.

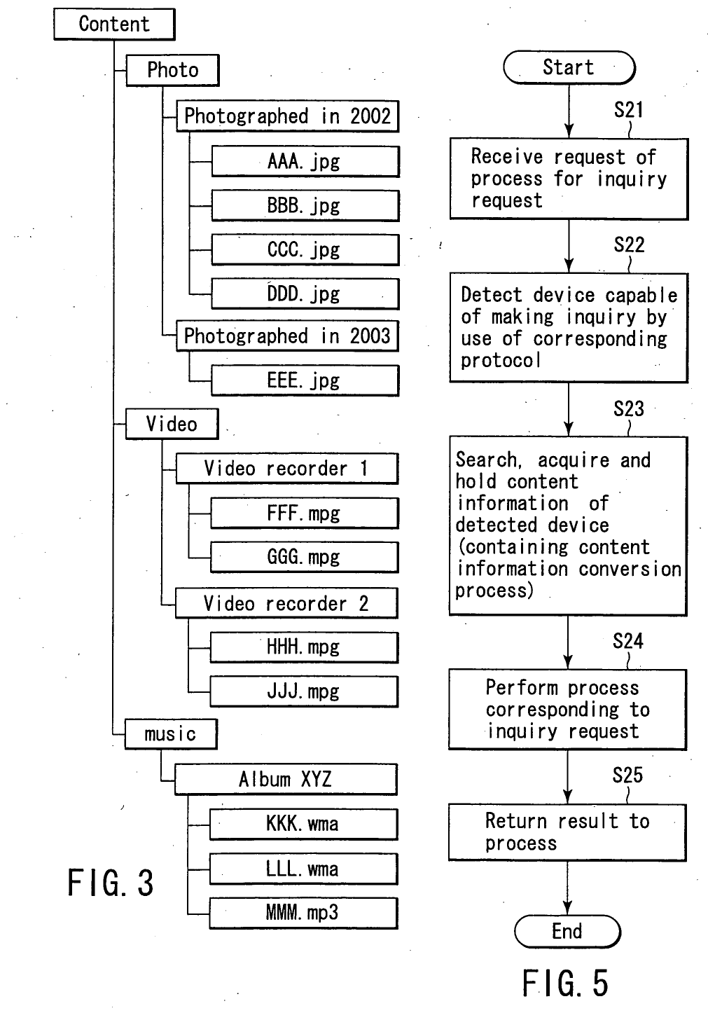

In the present embodiment, attention is paid to the content directory among the above items. For example, as shown in FIG. 3, the content directory is formed in a tree structure and information items indicating the respective contents are provided on the endpoints. For example, content information of a photo-file of “AAA.jpg” can be acquired by sequentially following the respective hierarchies (which are hereinafter called containers) of “photo”, “photographed in 2002” in the directory route.

Particularly, the media management section 11 of the present embodiment can deal with inquiry protocols inherent to the AV devices and corresponding in number to the types of the inquiry processing sections 32 prepared for the respective devices. Further, the media management section 11 can respond to an inquiry from an external controller (such as the PC 2) as the content directory of the UPnP AV. After this, the inquiry processing sections 32 are called monitors.

A region on the content directory which each monitor manages lies in a branch lower than a certain node (container) in the tree structure of the content directory. For example, in an example of the hierarchical structure of the content directory of FIG. 3, the container name of “video recorder 1” indicates a virtual monitor route container which is referred to as a base point by a monitor dealing with a specified hard disk video recorder. Further, containers corresponding to the devices “video recorder 1” and “video recorder 2” detected by the monitor respectively lie directly below the virtual monitor route containers. This is called a virtual monitor device route container. Below the virtual monitor route device container, content information stored in each of the accommodated AV devices can be observed as a container or item provided by CDS so as to be inquired by the PC 2. An object ID which the monitor route container has is set to a preset value for each monitor.

Next, the outline of the operation of the inquiry receiving section 31 is explained with reference to FIG. 4.

When receiving an inquiry (request) from the PC 2 (step S11), the inquiry receiving section 31 selects one of the inquiry processing sections 32 according to the inquiry to make a request for a process (step S12). Then, the inquiry receiving section 31 waits for the result of the process from one of the inquiry processing sections 32 receives to which the process is requested (step S13). After this, if the inquiry receiving section 31 receives the result of the process (“YES” in step S14), the inquiry receiving section 31 notifies the PC 2 of the process result as the inquiry result (step S15).

Next, the outline of the operation of the inquiry processing section 32 is explained with reference to FIG. 5.

When receiving an inquiry (request) (step S21), for example, the inquiry processing section 32 detects an AV device on the network which can be inquired by use of the protocol of the inquiry (step S22). Then, the inquiry processing section 32 acquires content information held by the detected AV device based on the inquiry protocol of the AV device, converts the content information into a preset standardized form (in this example, into the CDS form) and holds the thus converted information (step S23).

Further, the inquiry processing section 32 performs a process for, for example, retrieving the above stored content information according to the inquiry and the property of the AV device (step S24). Then, the inquiry processing section 32 returns a result which satisfies the condition as an inquiry response to the inquiry receiving section 31 (step S25).

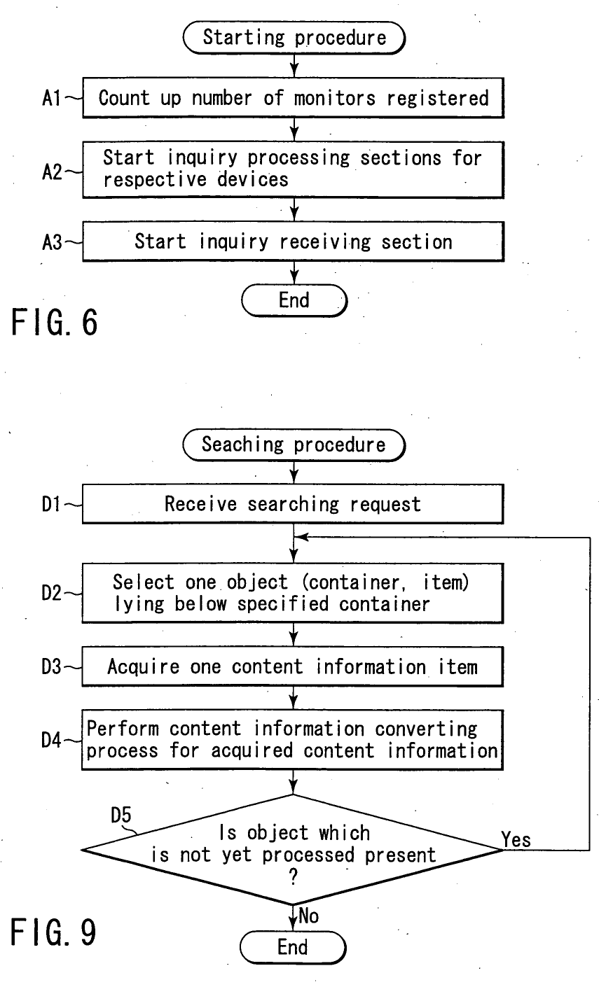

Next, the operation of the media management section 11 at the starting time is explained with reference to FIG. 6.

At the starting time, the media management section 11 recognizes the monitors registered in the media management section 11 and counts the number of monitors (step A1). After this, the media management section 11 starts to drive the inquiry processing sections 32 (step A2) and then starts to drive the inquiry receiving section 31 (step A3).

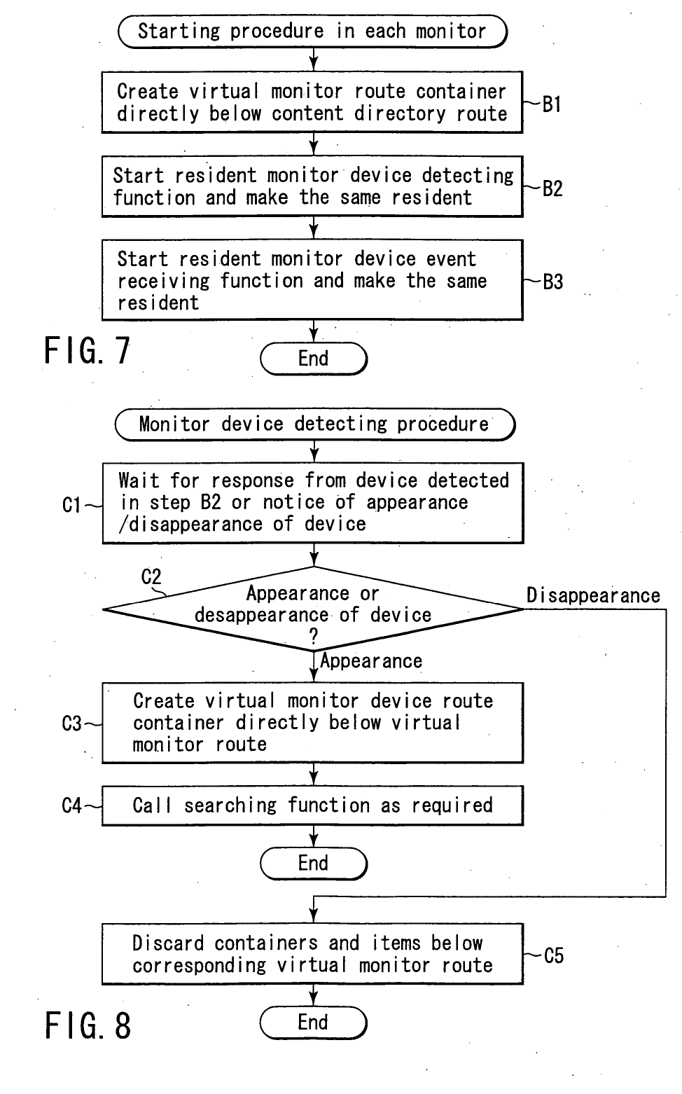

Next, the operation of each of the monitors (inquiry processing sections 32) at the starting time is explained with reference to FIG. 7.

At the starting time, each monitor creates a virtual monitor route container directly below the content directory route of the media management section 11 (step B1). Then, each monitor starts a preset monitor device detecting function (corresponding to the device detecting section 41) and make the same resident (step B2). Next, each monitor starts a monitor device event receiving function and make the same resident (step B3).

The detecting process in each monitor at the starting time can be selected from the following items.

1. To detect available peripheral devices:
(a) To unconditionally detect devices;
(b) To detect devices under a certain condition (for example, under a condition that the lower limit of the access frequency is specified).

2. To detect preset peripheral devices:

Next, the device detecting procedure by use of the monitor is explained with reference to FIG. 8.

First, the monitor waits for a response from a device detected in step B2 (FIG. 7) or a notice of appearance/disappearance of a peripheral device (step C1).

When appearance of the device is detected (step C2), a virtual monitor device route container is created directly below the virtual monitor route (step C3). Further, a searching function is called as required (depending on the set state of the monitor) (step C4).

When disappearance of the device is detected in step C2, the containers and items below a corresponding virtual monitor route are discarded (step C5).

As a result, the entrance of an inquiry relating to the AV devices which can be dealt with by the monitor can be acquired directly below the monitor device container. Then, the content information of the AV device can be developed below the container with the inquiry entrance used as a base point.

Next, the searching procedure by use of the monitor is explained with reference to FIG. 9.

First, when the monitor receives a searching request from another function (step D1), it selects one of the objects (containers, items) lying below the specified container as an object to be subjected to the following process (step D2).

The monitor acquires one of the content information items (step D3) and subjects the acquired content information to the content information converting process (step D4).

Then, the monitor checks whether an object which is not yet processed is present or not (step D5) and it performs the process starting from step D2 again if an object is present. If no object is present, content information obtained as the result after conversion is added to the content directory of the virtual monitor device and the process is terminated.

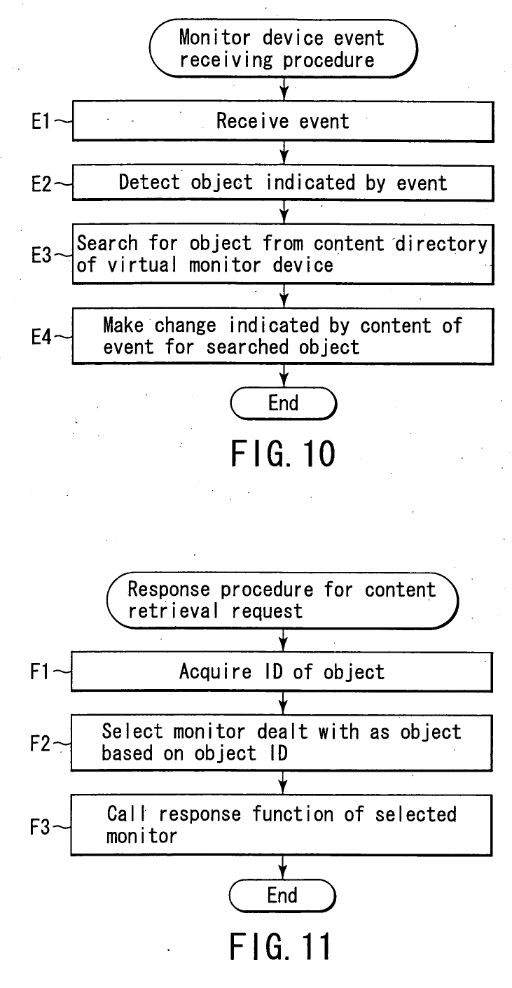

Next, the device event receiving procedure by use of the monitor is explained with reference to FIG. 10.

First, when the monitor receives an event from a device (step E1), it detects an object indicated by the event (step E2). After this, it retrieves the object from the content directory of the virtual monitor device (step E3). Then, it makes a change indicated by the content of the event for the retrieved object (step E4).

Next, the response procedure for a content retrieving request is explained with reference to FIG. 11.

First, an ID of an object is acquired (step F1). Then, a monitor dealt with as an object is selected based on the ID of the object (step F2) and a response function of a content retrieving request is called (step F3).

The procedure of the response function in each monitor is different according to the types of inquiries (requests). Various types of procedures corresponding to the types of inquiries are explained below.

(1) In the case of retrieving of content information:

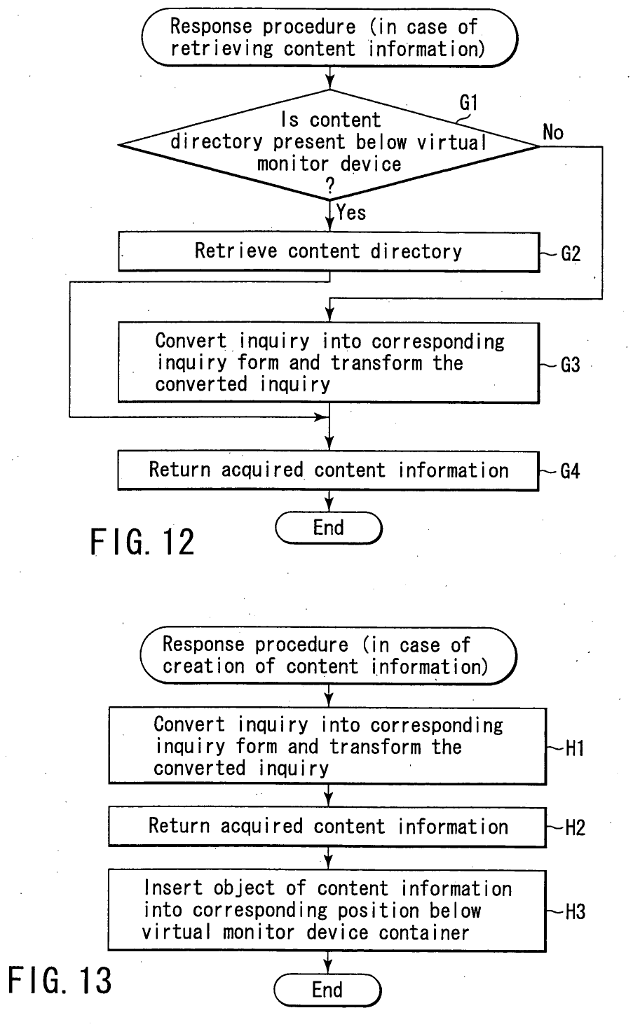

In FIG. 12, whether or not a content directory is constructed below the virtual monitor device container is determined (step G1).

If the content directory is constructed, it is retrieved (step G2). If the content directory is not constructed, an inquiry is converted into a corresponding inquiry form and the converted inquiry is transmitted (step G3). In this case, it is also possible to widely specify the inquiry condition at the inquiry time, acquire a large amount of content information and temporarily store the same in the monitor as a cache.

Finally, the acquired content information is returned to the request source (step G4).

If the types of inquiries (requests) correspond to creation, deletion or updating of content information, it is necessary to process content information on the actual AV device.

(2) In the case of creation of content information:

In FIG. 13, if an inquiry for creation of content information is received, an inquiry is converted into a corresponding inquiry form and the converted inquiry is transmitted (step H1). Then, the content information obtained as the result is returned to the inquiry source (step H2) and an object of the content information is inserted into a corresponding position below the virtual monitor device container (step H3).

(3) In the case of deletion of content information:

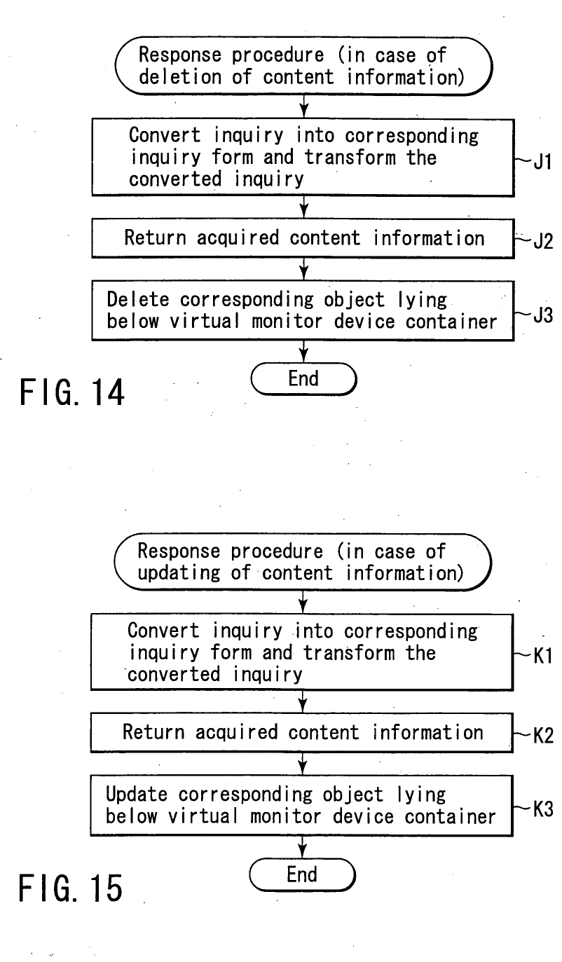

In FIG. 14, if an inquiry for deletion of content information is received, an inquiry is converted into a corresponding inquiry form and the converted inquiry is transmitted (step J1). Then, the content information obtained as the result is returned to the inquiry source (step J2) and the object lying below the virtual monitor device container is deleted (step J3).

(4) In the case of updating of content information:

In FIG. 15, if an inquiry for updating of content information is received, an inquiry is converted into a corresponding inquiry form and the converted inquiry is transmitted (step K1). Then, the content information obtained as the result is returned to the inquiry source (step K2) and the object lying below the virtual monitor device container is updated (step K3).

When an inquiry request from the PC 2 (as a controller) is distributed to each actual monitor, it is required to compute necessary monitors based on the object ID. As one of the methods to achieve this, a method for permitting a monitor identifier to be combined with an object ID having no structure in CDS and structuring the object ID can be provided. Further, when the monitor accommodates a plurality of devices, the cost required for selecting a necessary monitor based on the object ID can be reduced by containing the device identifiers in the object ID.

That is, if the original content identifier of the accommodated hard disk video recorder “video recorder 1” is “ABCDE”, the object ID in the CDS form corresponding to the content is expressed by a combination of the monitor identifier, AV device identifier and content identifier in the present embodiment. For example, as symbols for separation between the monitor identifier, device identifier and original content identifier in the object ID, marks of “_{“,”}_” are used.

Next, an example in which the actual AV device content information is converted into a CDS form is explained.

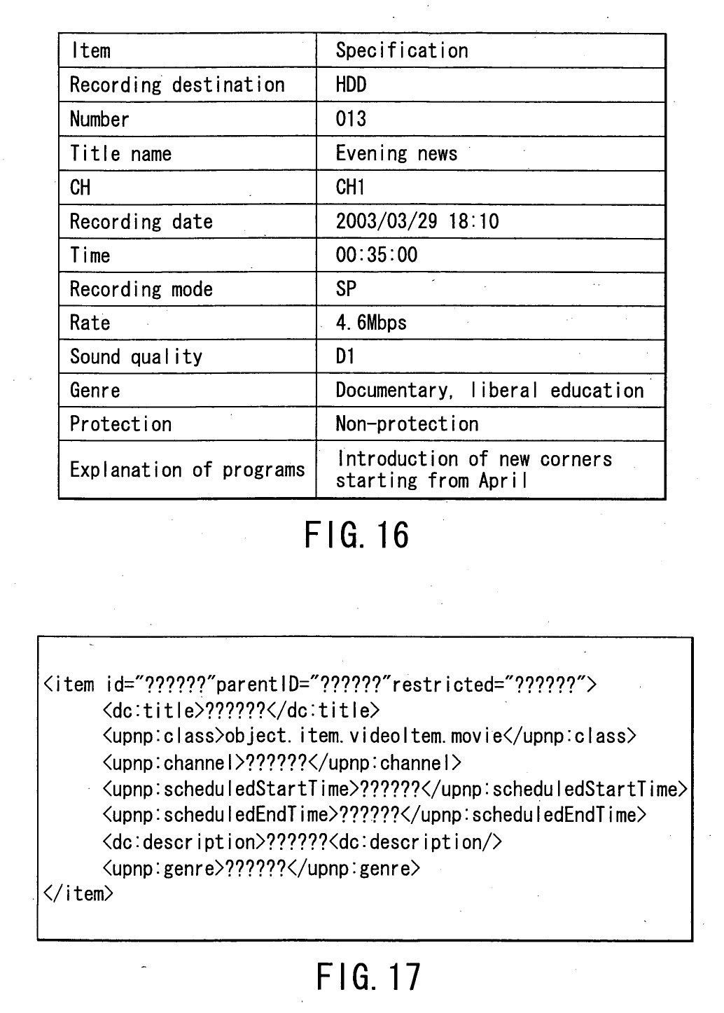

For example, it is assumed that an AV device is a hard disk video recorder and recorded content are held in a form shown in FIG. 16.

The above content information is converted into a form (in this example, into a CDS form) which is a standardized form. FIG. 17 shows an example of a CDS form template in the case of a hard disk video recorder.

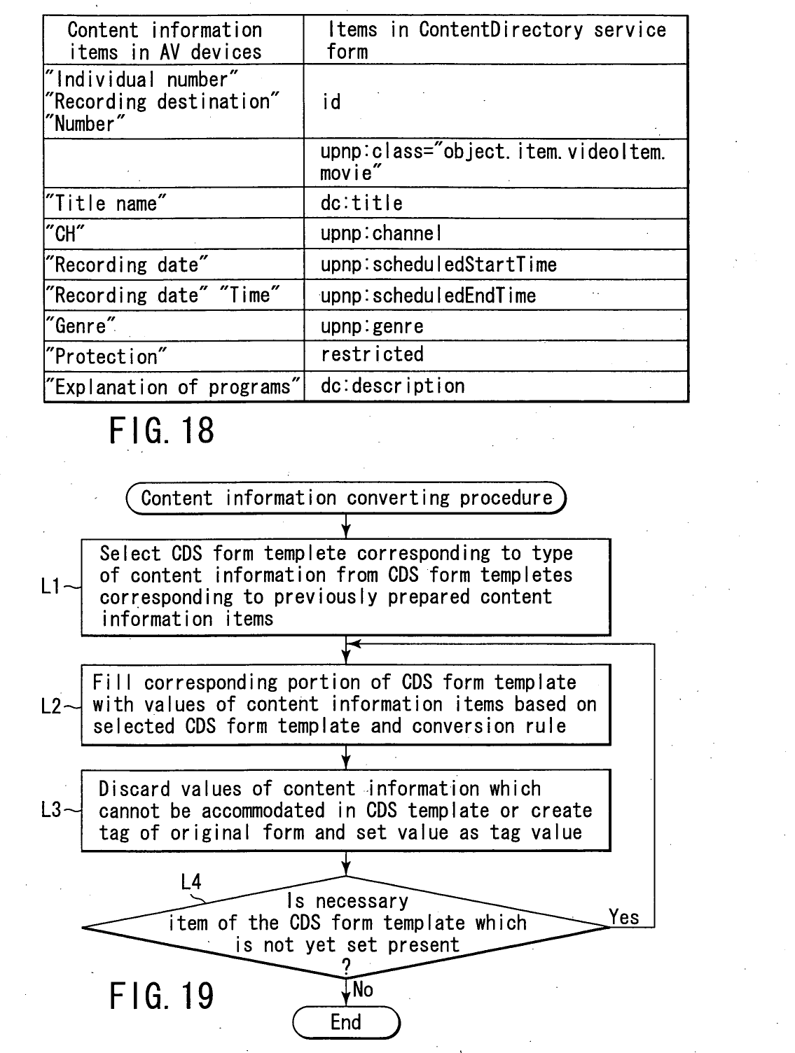

FIG. 18 shows an example of a rule applied in the case of a hard disk video recorder. FIG. 18 is a table showing the replacement of content of items of content information items inherent to the respective AV devices shown on the left side by respective items expressed in the CDS form shown on the right side. For example, as a “title name”, a character string having a value sandwiched between character strings “<dc:title>” and “</dc:title>” is output. It is necessary to create a value based on a plurality of items depending on the items. For example, since the recording end time is held in the case of the CDS form, it is necessary to derive the recording end time based on the recording start time and a recording time period when the AV device holds only the recording start time and the recording time period. Further, since an id value which is an identifier of each content information in the CDS form is required to be unconditionally determined in the CDS of the media management section 11, a combination of the inherent number of the AV device (for example, the manufacturer's serial number) with the “recording destination” and “number” is used as “id”.

Next, the content information converting procedure is explained with reference to FIG. 19.

A CDS form template corresponding to the type of the content information is selected from CDS form templates corresponding to previously prepared content information items (step L1).

Then, a corresponding portion of the CDS form template is filled with values of the content information based on the selected CDS form template and conversion rule (step L2).

After this, values of the content information which cannot be accommodated in the CDS template are discarded. Alternatively, a tag of its own definition is created and each value is set as the value of the tag (step L3).

Finally, whether a necessary item of the

CDS form template which is not yet set is left behind or not is determined (step L4), and if any necessary item is left behind, steps L2, L3 are repeatedly performed until no necessary item is left behind.

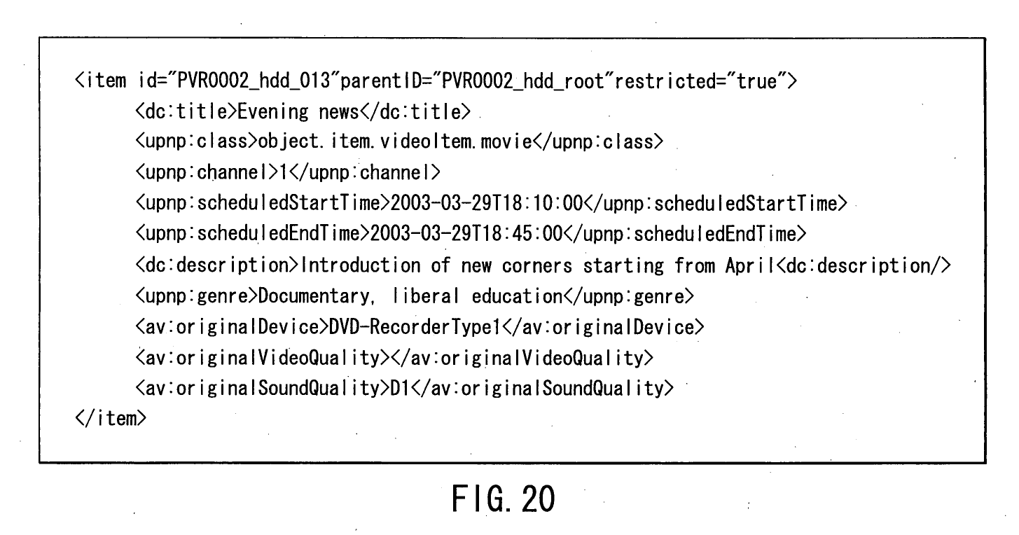

The result obtained by converting the above content into the CDS form is shown in FIG. 20, for example.

In this case, title information is arranged in a portion sandwiched between “<dc:title>” and “</dc:title> and time is arranged in a portion sandwiched between “<scheduleStartTime>” and “</scheduleStartTime>”. Further, a device in which the content information is stored is a video recorder, a channel is CH1 which is not an external input, and <upnp:class>object.item.videoItem.videoBroadcast</upnp: class> which indicates a person who has recorded the video broadcasting is set in correspondence thereto.

Further, information which is left behind as original information is arranged in a portion sandwiched between <av:????> and </av:????>.

As described so far, since the above information items are different for the respective types of the devices, the conversion procedures correspond to the respective types. Since the finally converted output is generated in an unconditionally defined form, the PC 2 which is a controller is only required to interpret information based on the output.

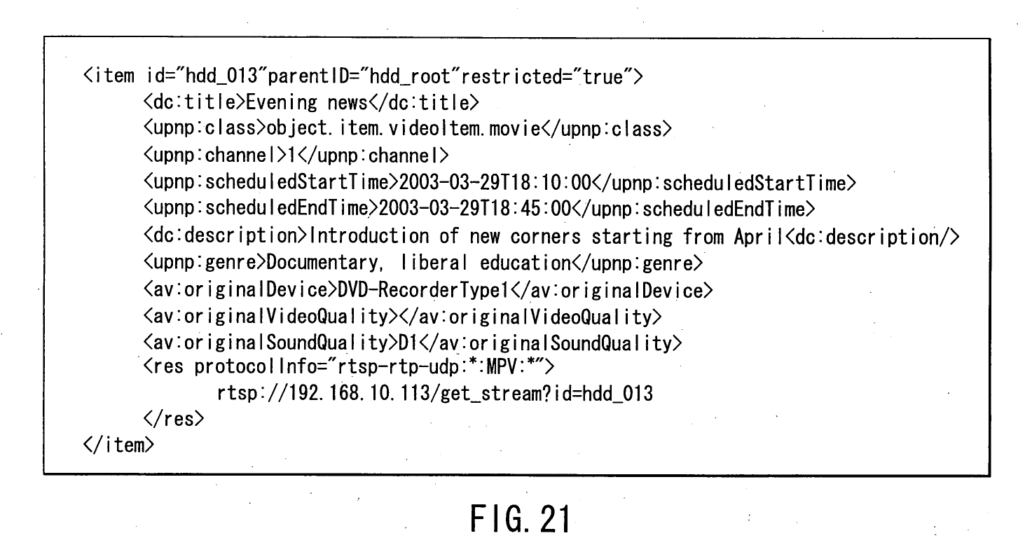

Some of the AV devices can transfer content to the PC 2 and other AV devices (such as the digital TV 3, audio device 4, UPnP device 5) on the network use their own communication device and the home network station, and reproduce the same. In this case, information indicating a location of the content is contained in the above information in a URL (Uniform Resource Locator) form so that the PC 2 (as a controller) can specify reproduced content. One example is shown in FIG. 21.

The example of FIG. 21 indicates that the MPEG video transmission can be attained by use of the RTPS protocol from a pass of /ger_stream?id=hdd_{—}013 of the host in IP addresses 192.168.10.113.

In this case, it should be noted that the transmission source of media transmission is not the media management section 11 but a preset AV device.

The present invention is effective for a device which provides an existing UPnP AV Content Directory service. That is, the media management section 11 which is used as a media server can make a content inquiry to a CDS device based on different UPnP AV and return the result as a result of the media management section 11 to the PC 2 which is the controller. In this case, the PC 2 can directly make an inquiry to the AV device. However, if the inquiry retrieving condition issued from the controller cannot be dealt with by the AV device, this can be coped with by permitting the media management section 11 to make a basic inquiry to the AV device, perform a retrieving or filtering process with respect to the response of the AV device and return the result to the controller 10.

In this case, the controller recognizes that the corresponding content are managed by the media management section 11 and tends to perform the succeeding content transmission and reproduction operations with respect to the media management section 11. Originally, the above operations should be performed with respect to the AV device.

Further, the present invention can be applied to a network other than a TCP/IP network. For example, the present invention can be applied to the IEEE 1394 network or a bus in the device. In the latter case, an inquiry relating to content information held in a sub device connected to the bus is made according to the UPnP AV Content Directory form.

Thus, according to the present embodiment, the form and inquiry protocol of content information of each AV device which holds content are respectively converted into a standardized content information form and inquiry protocol. Further, the content information is positioned in one point of the content information space managed by the media server. Therefore, the PC 2 which is a controller can transmissively acquire content information of each AV device irrespective of the presence of each AV device and a difference in the protocol of each AV device by making an inquiry to the media management section 11 which is the media server by use of the standardized content information form and inquiry protocol.

As described above in detail, according to the present invention, it is possible to make access by the standardized inquiry protocol to content information which is required to be retrieved by use of various inquiry protocols.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A content information management apparatus comprising:
a collection processing unit which collects content information items indicating attributes of contents stored in different specific forms in storage devices connected to networks using different protocols;
a conversion processing unit which converts each of the content information items collected by the collection processing unit into content information of a standardized form; and
a display which displays the content information.

2. The content information management apparatus according to claim 1, wherein the conversion processing unit includes a plurality of conversion processors which are provided according to types of the networks to be connected.

3. The content information management apparatus according to claim 2, wherein said collection processing unit comprises a plurality of collection processors which collect said content information items from the storage devices connected to corresponding ones of the networks.

4. The content information management apparatus according to claim 3, further comprising an information creating unit which creates information by unifying content information items of each standardized form output from each of the plurality of collection processors.

5. A content information management method comprising:
collecting a content information item indicating an attribute of content stored in a first form in a first storage device connected to a network using a first protocol and a content information item indicating an attribute of content stored in a second form in a second storage device connected to a network using a second protocol; and
displaying each of the collected content information items in a standardized form.

6. The content information management method recording to claim 5, further comprising creating a play list based on the collected content information items and displaying the play list.

7. The content information management method according to claim 6, further comprising sequentially reproducing and outputting individual content indicated on the display of the play list from a corresponding one of the storage devices.

8. The content information management method according to claim 6, further comprising converting control information from a certain device into control information which is capable of being dealt with in the standardized form, and performing a process corresponding to the converted control information.

9. A content information management apparatus in which a plurality of devices using different protocols are connected via networks, comprising:
an inquiry receiving unit which receives from an arbitrary one of the plurality of devices an inquiry relating to content information held in another one of the plurality of devices and returns a result of the inquiry; and
an inquiry processing unit which acquires content information items held in the plurality of devices based on inquiry protocols of the respective devices, converts the content information items into a standardized form and holds the converted content information, retrieves the converted content information according to the inquiry received by the inquiry receiving unit and returns a result which satisfies a condition to the inquiry receiving unit as an inquiry response.

10. The content information management apparatus according to claim 9, wherein the inquiry processing unit acquires an inquiry result by making an inquiry by use of an inquiry protocol of a targeted device via a network.

11. The content information management apparatus according to claim 9, wherein the inquiry processing unit creates a reproduction list of contents held in each device in a standardized form based on the converted content information and returns the reproduction list as an inquiry response to the inquiry receiving unit when receives from one of the plurality of devices a display request for a reproduction list of contents held in another ones of the plurality of devices.

12. The content information management apparatus according to claim 11, further comprising a reproducing unit which is capable of sequentially acquiring contents described in the reproduction list from the corresponding devices and output the acquired contents to the arbitrary one of the plurality of devices.

13. A content information management apparatus in which a first device and at least one second device which holds content information being not accessible from the first device are connected via networks, comprising:
a communicating unit capable of performing communication with the first device and the at least one second device,
an inquiry receiving unit which receives an inquiry relating to content information of the at least one second device from the first device via the communicating unit and returns a result of the inquiry; and
at least one inquiry processing unit which is provided for the at least one second device and processes the inquiry received by the inquiry receiving unit,
wherein the inquiry receiving unit selects one of the at least one inquiry processing unit according to the inquiry, leaves an inquiry process up to the selected inquiry processing unit, waits for a processing result of the selected inquiry processing unit, receives the processing result and notifies the first device of the processing result as an inquiry result via the communicating unit, and
the selected inquiry processing unit includes:
(1) a detection processing unit which detects the second device on a network which is capable of being inquired by use of an inquiry protocol of the second device in advance or when an inquiry is received,
(2) a searching unit which: (a) acquires content information held in the second device detected by the detection processing unit based on the inquiry protocol of the second device, (b) converts the content information into a standardized form and (c) holds the converted content information, and
(3) the selected inquiry processing unit retrieves the converted content information acquired by and held in the searching unit according to the inquiry and a property of the second device and returns a result which satisfies a condition to the inquiry receiving unit as an inquiry response.

14. The content information management apparatus according to claim 13, wherein the inquiry processing unit acquires an inquiry result by making an inquiry with respect to the second device detected by the device detection processing unit based on the inquiry protocol of the second device.

15. A content information management method applied to a content information management apparatus in which a plurality of devices using different protocols are connected via networks, comprising:
receiving from an arbitrary one of the plurality of devices an inquiry relating to content information held in another one of the plurality of devices;
acquiring content information items held in the plurality of devices based on inquiry protocols of the respective devices,
converting the content information items into a standardized form,
storing the converted content information,
retrieving the converted content information according to the received inquiry;
acquiring a result among the converted content information; and
transmitting the acquired result to the arbitrary one of the plurality of devices.

16. The content information management method according to claim 15, wherein acquiring the result includes acquiring an inquiry result by making an inquiry by use of an inquiry protocol of a targeted device via a network.

17. The content information management method according to claim 15, wherein acquiring said result includes creating a reproduction list of contents held in each device in a standardized form based on the converted content information and returning the reproduction list as an inquiry response to the arbitrary one of the plurality of devices, when said arbitrary one of the plurality of devices issues a display request for a reproduction list of contents held in another ones of the plurality of devices.

18. The content information management method according to claim 17, further comprising sequentially acquiring contents described in the reproduction list from the corresponding devices and output the acquired contents to the arbitrary one of the plurality of devices.

19. A content information management method applied to a content information management apparatus in which a first device and at least one second device which holds content information being not accessible from the first device are connected via networks, comprising:
receiving an inquiry relating to content information of the at least one second device from the first device via a communication medium,
detecting the at least one second device on a network which is capable of being inquired by use of an inquiry protocol of the at least one second device in advance or when the inquiry is received,
acquiring content information held in the detected at least one second device based on the inquiry protocol of the at least one second device, converting the acquired content information into a standardized form content information and storing the same, and
retrieving the stored standardized content information according to the inquiry and a property of the second device and returning a result which satisfies a condition to the first device as an inquiry response.

20. The content information management method according to claim 19, further including acquiring an inquiry result by making an inquiry with respect to the detected at least one second device based on the inquiry protocol of the at least one second device.

21. A content information management apparatus comprising:
collection processing means for collecting content information items indicating attributes of contents stored in different specific forms in storage devices connected to networks using different protocols;
conversion processing means for converting each of the content information items collected by the collection processing means into content information of a standardized form; and
means for displays the content information.

22. A content information management apparatus comprising:
a data processing unit operative under program control for:
(1) collecting content information items indicating attributes of contents stored in different specific forms in storage devices connected to networks using different protocols;
(2) converting each of the content information items collected by the collection processing unit into content information of a standardized form; and
a display coupled to said data processing unit for displaying the content information.
